(19) United States
(12) Patent Application Publication
(10) Pub. No.: US 2025/0134330 A1
(43) Pub. Date: May 1, 2025

(54) SUCTION DEVICE WITH THROTTLE VALVE AND METHOD FOR DEDUSTING A FILTER IN SUCH A SUCTION DEVICE

(71) Applicant: Hilti Aktiengesellschaft, Schaan (LI)

(72) Inventors: Uwe BEHRINGER, Muenchen (DE); Roman PODHORNY, Buchloe (DE); Xaver HANSLMEIER, Mauerstetten (DE)

(21) Appl. No.: 18/835,819

(22) PCT Filed: Jan. 30, 2023
(86) PCT No.: PCT/EP2023/052146

§ 371 Date: Aug. 5, 2024

(30) Foreign Application Priority Data
Feb. 9, 2022 (EP) 22155856.2

(51) Int. Cl. A47L 9/20; A47L 7/00; A47L 9/00; A47L 9/10

(52) U.S. Cl. CPC A47L 9/20; A47L 9/0072; A47L 9/106; A47L 7/0095

(57) ABSTRACT

A suction device having a dirt collection container, a filter and a suction motor, wherein a suction flow is generated by the suction motor, the suction flow flowing from the dirt collection container through the filter in the direction of the suction motor. The suction device is designed to carry out dedusting of the filter while the suction mode of the suction device is in progress, by a backflushing flow R being generated from a clean side of the filter in the direction of a dirty side of the filter. The suction device includes a throttle valve provided on a dirty side of the filter to throttle the suction flow S such that the backflushing flow R is intensified. A method for dedusting a filter, filter dedusting being carried out while the suction mode of the suction device is in progress, by a backflushing flow being generated from a clean side of the filter in the direction of a dirty side of the filter, with throttling of the suction flow by a throttle valve leading to intensification of the backflushing flow.

### BACKGROUND OF THE INVENTION

The present invention relates to a suction device having a dirt collection container, a filter and a suction motor, wherein a suction flow is generated by means of the suction motor in a suction mode of the suction device, said suction flow flowing from the dirt collection container through the filter in the direction of the suction motor.

In the field of industrial vacuum cleaners, devices are known, for example, with which both liquid and solid substances can be sucked in. Such suction devices are usually referred to as wet-dry vacuum cleaners. The solid substances may be, for example, dust, drilling dust or demolition material. The liquid material may be cooling or flushing water which, together with the solid material, can form a sludge-like mass. Conventionally, a suction device is used in conjunction with a power tool that generates dust or drilling dust. The dust-generating work carried out with the power tool is preferably referred to as “application” within the meaning of the invention.

In addition, devices of this type that can only suck in solid material are known in the field of industrial vacuum cleaners. A common feature of both types of vacuum cleaner is that they conventionally have a dirt collection container, a filter, a motor and a turbine, with the turbine being driven by the motor. The solid and/or liquid suction material can be sucked in by the air flow, which is generated by the rotational movement of the turbine. For this purpose, the suction device expediently has a suction hose, on the front end of which a nozzle or a power tool can be mounted. The dirt collection container is used to store the suction material which has been sucked in, until the dirt collection container is emptied. The dirt collection container can in particular have a suction opening to connect a suction hose. The filter is designed to separate or segregate the suction material present in the air flow from the air flow. This separation of air flow and suction material is preferably referred to as “filtering” or “filtration” within the meaning of the invention. The filter is conventionally arranged between the dirt collection container and the motor. That side of the filter which faces the dirt collection container is referred to as the first side or the dirty side of the filter within the meaning of the invention, while that side of the filter which faces the suction motor is referred to as the second side or the clean side of the filter. During the suction mode, the air flow conventionally flows from the dirt collection container in the direction of the suction motor, i.e. from the dirty side of the filter in the direction of the clean side.

The suction material sucked in by the suction device is either deposited in the dirt collection container or gets caught in the filter of the suction device. An accumulation of suction material in the region of the filter can lead to the formation of a solid filter cake, as a result of which the flow resistance caused by the filter can increase significantly. The flow resistance brakes or throttles the suction air flow with which the suction material is sucked in, and can thereby disadvantageously reduce the suction power of the suction device. In order to avoid such an undesirable reduction in suction power, the filters of suction devices are cleaned regularly. This cleaning of a suction device filter is referred to as “filter dedusting” within the meaning of the invention.

### SUMMARY OF THE INVENTION

Various methods for filter dedusting have been proposed in the prior art. For example, backflushing solutions are known in which the flow direction of the air flow is reversed. As a result, the air flow flows from the clean side of the filter toward its dirty side for a short time. In order to enable this reversal of the flow direction, the pressure in the suction device is increased on the clean side of the filter, specifically preferably to a level which is above the pressure level on the dirty side of the filter. The efficiency of the filter dedusting depends in particular on the pressure difference between the dirty side of the filter and the clean side of the filter. A small pressure difference between the dirty side and the clean side of the filter of the suction device can lead to low efficiency of the filter dedusting, and therefore the filter may not be optimally dedusted under some circumstances. This may disadvantageously lead to a permanently reduced suction power of the suction device such that suction tasks to be carried out take longer and tie up more staff. In addition, the change intervals at which the filter of the suction device has to be replaced in order to guarantee or maintain a certain suction power may be shortened.

For example, DE 690 23 165 T2 discloses a remote control device for extraction or ventilation systems with a chamber, a driven extraction fan and at least one pipe.

EP 3 827 724 A1 discloses an extraction system comprising a central extraction system, a plurality of suction points fluidically connected to the extraction system, each with a throttle valve for each suction point and with a means for manually adjusting the throttle valve.

DE 20 2021 001444 U1 describes a vacuum cleaner with a tube extension that can be used as a catching tube for catching, viewing, studying and re-releasing insects.

DE 10 2015 108 559 A1 discloses an air filter that can be backflushed, in particular for a vacuum cleaner, with a filter element separating a clean air space from a suction material space, with the vacuum cleaner being able to be operated in a filter mode or in a backflushing mode.

US 2017 0151 524 A1 describes a system and a method for backflushing a vacuum cleaner filter.

An object on which the present invention is based is that of overcoming the above-described defects and drawbacks of the prior art and of providing a suction device and a method for filter dedusting, with which the efficiency of the filter dedusting can be improved and optimized.

According to the invention, a suction device is provided having a dirt collection container, a filter and a suction motor, wherein a suction flow is generated by means of the suction motor in a suction mode of the suction device, said suction flow flowing from the dirt collection container through the filter in the direction of the suction motor. The suction device is designed to carry out dedusting of the filter while the suction mode of the suction device is in progress, by a backflushing flow R being generated from a clean side of the filter in the direction of a dirty side of the filter. The suction device comprises a throttle valve, the throttle valve being provided on a dirty side of the filter and being designed to throttle the suction flow S such that the backflushing flow R is intensified by the throttling of the suction flow S. Within the meaning of the invention, it is very particularly preferred that the throttle valve is arranged in the suction flow. As a result, the suction flow can be adjusted and regulated, in particular throttled, by the throttle valve. Within the meaning of the invention, the throttle valve is preferably also referred to as a “throttle”, the terms preferably being used synonymously.

The suction device can comprise a suction device head in an upper region of the suction device and a dust collection container in a lower region of the suction device. An inlet opening can be provided in the lower region of the suction device, in particular in the region of the dust collection container. A suction hose can be connected to said inlet opening, the suction flow S being sucked into the suction device through the suction hose. A power tool, which generates dust during its operation, can be arranged on a front side of the suction hose. This dust can be extracted through the suction hose by the suction device. The rear side of the suction hose can lead through the inlet opening into the dust collection container of the suction device such that the dust-air mixture sucked in can be sucked into the dust collection container. The dirty side of the filter of the suction device preferably faces the dust collection container, while the clean side of the filter preferably faces the upper region of the suction device and can be oriented in the direction of the suction motor. The throttle is preferably located on the dirty side of the filter and in the suction flow. Advantageously, the provision of the throttle valve on the dirty side of the filter of the suction device enables dynamic control and regulation of a filter dedusting process, the filter dedusting process being able to be optimized by the throttle valve in particular with regard to its duration, its quality and the time at which it takes place. In particular, the use of a throttle valve in the flow path through the suction device enables the filter to be dedusted so as to particularly meet requirements, in the sense that the filter dedusting can be adapted to different applications and connected power tools. This can be done, for example, by defining design points that can be controlled depending on the application or the connected power tool. In particular, the pressure conditions in the suction device can be adjusted by the throttle valve in such a way that a particularly efficient filter dedusting can be provided.

Within the meaning of the invention, it is preferred that the dedusting process of the suction device is undertaken by backflushing of the filter of the suction device. In the process, ambient air is admitted into the suction device on the clean side of the filter such that the pressure in the suction device, in particular on the clean side of the filter, preferably rises suddenly. The ambient air can be admitted on the clean side of the filter preferably through valves that close or open up a further inlet opening. The pressure on the clean side of the suction device is briefly higher than the pressure in the dust collection container, i.e. on the dirty side of the filter of the suction device, because of the preferably sudden increase-caused by the penetrating ambient air. In this way, there is advantageously a backflushing flow through the filter, with the backflushing flow flowing from the clean side in the direction of the dirty side of the filter and thereby dedusting the filter. The backflushing can be maintained in particular until similar pressure conditions prevail on the clean side of the filter and in the dust collection container, i.e. until the pressures have equalized. It is preferred within the meaning of the invention that the ambient air penetrating the suction device as a result of the opening of the valve acts directly on the filter and generates the backflushing flow. However, it can also be preferred within the meaning of the invention that the penetrating ambient air acts indirectly on the filter in the sense that pistons or membranes transfer the penetrating air flow to the filter such that the filter itself does not come into contact with the penetrating, unfiltered ambient air. Pistons or membranes can generate an air cushion and push it in front of them, said air cushion being able to generate a backflushing flow which then flows through the filter from the clean side in the direction of the dirty side and thereby dedusts the filter.

This dedusting process can be supported by the provision of the throttle valve, by the suction flow being throttled by the throttle. The throttle valve is preferably arranged in the suction flow before the dust collection container and is designed to control, in particular to increase, the negative pressure in the dust collection container shortly before the filter dedusting or during the filter dedusting. Within the meaning of the invention, the wording “increasing the negative pressure” preferably means that the pressure in the dust collection container falls (further). In this respect, an increase in the negative pressure within the meaning of the invention can preferably also be referred to as a pressure drop. By increasing the negative pressure, the pressure difference between the clean side of the filter on the one hand and the dust collection container on the other hand can advantageously increase such that a particularly strong backflushing flow through the filter of the suction device is generated.

The throttle valve is designed to throttle the suction flow. The term “throttling” is used within the meaning of the invention in the sense of “continuous switching”. Within the meaning of the invention, it is preferred that the throttle valve is switchable substantially continuously. Within the meaning of the invention, this preferably means that the throttle can not only be completely open (100% degree of opening) or completely closed (0% degree of opening), but preferably can also take up any intermediate stage, i.e. preferably continuously variable degrees of opening between 0 and 100%. The throttle can preferably not only switch between the “open” and “closed” settings in a binary manner, but can also take up intermediate stages, in order for example to permit degrees of opening of the inlet opening of the suction device of 15%, 20%, 25%, 33.3%, 43.6%, 50%, 67%, 75%, etc. The present invention differs from solutions in which the suction flow is completely interrupted by the capability of the throttle valve not only to completely interrupt the suction flow or to allow it to pass unrestrictedly, but also to throttle it in the sense of “continuous switching”.

The throttle valve or its degree of opening can preferably be controlled by a central control unit of the suction device, said central control unit of the suction device preferably being designed to control the entire dedusting process.

It is preferred within the meaning of the invention that the throttle valve can be actuated manually or that the throttle valve can be activated electrically. It is very particularly preferred within the meaning of the invention that the entire dedusting process can be initiated manually, i.e. can be started, for example, by operation by the user of the suction device. This manual start of the dedusting process can preferably also be used to actuate the throttle valve such that there is a brief throttling of the suction flow. With such a global control of the dedusting process, the throttle can be opened or closed by a central control unit as part of the dedusting process, and therefore separate actuation of the throttle valve can be omitted. The dedusting process can preferably be controlled by the central control unit of the suction device. When the throttle is actuated manually, a user of the suction device closes the throttle valve manually such that the suction flow into the suction device can be briefly throttled.

Typical throttling times may be in a range of 10 to 150 ms. Of course, other throttling times are also possible, for example up to 200 or 300 ms, as well as all intermediate values.

The dirty side of the filter is preferably that side of the filter which becomes clogged with dirt and dust during the suction mode of the suction device. The dirty side preferably faces the dirt collection container and the inlet opening of the suction device. The filter of the suction device is preferably located in a flow channel or flow path which runs from the inlet opening through the dirt collection container and through the filter in the direction of the suction motor of the suction device. When the suction motor is in operation, the suction flow which is generated by the suction motor flows through this flow channel or flow path. For this purpose, the suction motor can comprise a turbine or a compressor. By increasing the negative pressure on the dirty side of the filter of the suction device, the pressure difference between the dirty side and the clean side of the filter can advantageously be increased and in this way the efficiency of the dedusting of the filter can be increased. Owing to the greater pressure difference between the dirty side and the clean side of the filter, a stronger backflushing flow through the filter can advantageously be achieved, and therefore the filter can be backflushed by a stronger air flow and dedusted better and more efficiently. A further advantage associated with the provision of a throttle in the flow channel of a suction device is that the filter can be dedusted while a suction mode of the suction device is in progress. As a result, it is possible to work particularly efficiently with the suction device and suction work to be done can be carried out quickly and with a low amount of staff. In particular, there are no undesirable breaks in work during which the suction mode has to be interrupted due to a possible dedusting of the filter.

The dedusting of the filter of the suction device can be further improved if, instead of the manually actuable throttle valve, an electrically activatable and in particular controllable and regulable throttle is used. The manually actuable throttle can adversely affect the suction power during the suction mode if the suction flow is interrupted for too long by the throttling. If the suction flow through the throttle is reduced for too long, the negative pressure prevailing in the dust collection container during the suction mode can collapse to too great an extent such that the negative pressure can only be restored slowly and laboriously after the filter dedusting has ended. The electrically activatable throttle valve can be regulated and/or controlled in particular highly dynamically such that a quantity of inflowing suction flow through the at least one inlet opening into the suction device can be adjusted so as to meet requirements. In particular, the pressure on the dirty side of the filter of the suction device can be adjusted by providing an adjustable, preferably electrically actuable, throttle valve. Furthermore, the cross section of the flow channel between the inlet opening and the suction motor can be adjusted particularly precisely and so as to meet requirements using an electrically activatable throttle. The advantages of the invention and the associated adjustability of the filter dedusting efficiency consist in that the quality of the filter dedusting is, for example, independent of the suction hose used or the diameter thereof. Tests have shown that the filter dedusting efficiency achieved with the invention is also independent of the application or the power tool in the context of which the suction device with a throttle valve is used. In other words, the quality of the filter dedusting advantageously does not depend on the connected power tool or the dust-generating work carried out with it (“application”), but rather the quality of the filter dedusting can be adjusted with the aid of the throttle valve. This advantage is achieved in particular when an electrically activatable, and thus in particular controllable and regulable, throttle valve is used in the suction mode.

In particular, the pressure drop in the dust collection container of the suction device can be adjusted with the throttle. Advantageously, with the provision of the throttle, the conflict of objectives within the suction mode can be optimally resolved, with a strong pressure drop being desirable on the one hand to enable efficient filter dedusting, but on the other hand possibly impairing the suction power of the suction device. In particular, an electrically activatable throttle can enable a particularly finely adjustable regulation and/or control of the suction flow or the pressure drop here such that a pressure or pressure drop on the dirty side of the filter of the suction device can be adjusted in order to provide optimum dedusting of the filter in the suction device. Tests have also shown that particularly good timing of the filter dedusting is made possible with the throttle. In other words, the filter dedusting can be optimally placed in terms of time in the operation of the suction device, such that, on the one hand, an optimum dedusting of the filter and, on the other hand, a particularly low adverse effect on the suction mode of the suction device are ensured.

Within the meaning of the invention, it is preferred that the throttle is arranged in the region of the at least one inlet opening in the region of the dirt collection container, with the suction flow being able to flow into the suction device through the inlet opening. The inlet opening may be for example an opening for the suction hose. With the provision of the throttle valve in the region of the inlet opening of the suction device, the invention differs from solutions in which valves or throttle valves are arranged in other regions of a suction device or of the suction hose. In the context of the present invention, the throttle is preferably present in the transition region from the suction hose to the suction device. The invention is based on the concept that the throttle is arranged in the suction flow and on the dirty side of the filter of the suction device, so that the suction flow can be throttled by the throttle, i.e. preferably can be continuously adjusted.

The throttle valve can preferably also be arranged between the at least one inlet opening and the filter, such that it is arranged in particular on the dirty side of the filter of the suction device. By providing the throttle in the suction flow on the dirty side of the filter, the throttle valve can be used in particular to adjust the pressure or the pressure drop on this dirty side of the filter and thus to optimize the efficiency of the filter dedusting by setting an optimum pressure difference between the dirty side and clean side of the filter.

The setting of the optimum pressure difference can be achieved in particular by the throttle valve being designed to adjust a cross section of a flow channel in the suction device. The throttle valve can preferably be designed to adjust the cross section of the flow channel in a range between 0 and 100%. In other words, it is possible with the throttle valve not only to change between the “open” position (essentially 100% opening of the inlet opening and essentially 100% opening of the flow channel) and “closed” position (essentially 0% opening of the inlet opening and essentially 0% opening of the flow channel) in a binary manner but a fine adjustment of intermediate degrees of opening is possible. As a result, a particularly finely adjustable and preferably continuous regulation and adjustability of the suction flow, the pressure or the pressure drop or the pressure difference between the dirty side and clean side of the filter can be made possible. For example, the throttle valve can be opened by 17%, 20%, 25%, 33.3%, 46.4%, or any other percentage between 0 and 100%.

It is preferred within the meaning of the invention that the throttle valve is designed to adjust a pressure on a dirty side of the filter of the suction device. In particular, the negative pressure on the dirty side of the filter can be increased by briefly throttling the suction flow before and/or during filter dedusting. Within the meaning of the invention, this preferably means that the absolute pressure on the dirty side of the filter drops or is reduced for a short time. By throttling the suction flow, the pressure on a dirty side of the filter of the suction device can advantageously be controlled or regulated. In particular, the pressure on the dirty side of the filter of the suction device can be influenced by varying or changing a flow rate through the at least one inlet opening.

In a second aspect, the invention relates to a method for dedusting a filter in a suction device. The terms, definitions and technical advantages introduced for the suction device preferably apply to the filter dedusting method in an analogous manner. The filter dedusting method is characterized by the following method steps:
a) operating the suction device in a suction mode,
b) carrying out dedusting of the filter while the suction mode is in progress, by a backflushing flow being generated from a clean side of the filter in the direction of a dirty side of the filter,
c) throttling a suction flow by a throttle valve to intensify the backflushing flow.

It is a substantial advantage of the invention that the filter dedusting can be carried out while the suction mode of the suction device is in progress. In particular, a simultaneous dedusting of the at least one filter of the suction device is possible while the suction mode of the suction device is in progress. As a result, work can be carried out with the suction device particularly quickly and without interruption.

It is preferred within the meaning of the invention that the throttle valve is actuated manually or the throttle valve is activated electrically. In addition, a cross section of a flow channel in the suction device can be adjusted by the throttle valve in a range between 0 and 100%. This advantageously also makes it possible to adjust the pressure on a dirty side of a filter of the suction device by means of the throttle valve.

Advantageously, with the method, dynamic control and regulation of the filter dedusting process can be made possible, the throttle optimizing the filter dedusting in particular with regard to its duration, its quality and the time at which it takes place. In particular, the invention enables the filter to be dedusted so as to particularly meet requirements, in the sense that the filter dedusting can be adapted to different applications and connected power tools.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

Identical and similar components are denoted by the same reference signs in the figures, in which:

FIG. 1 shows a view of a preferred embodiment of a suction device in the suction mode

FIG. 2 shows a view of a preferred embodiment of a suction device during the filter dedusting

### DETAILED DESCRIPTION

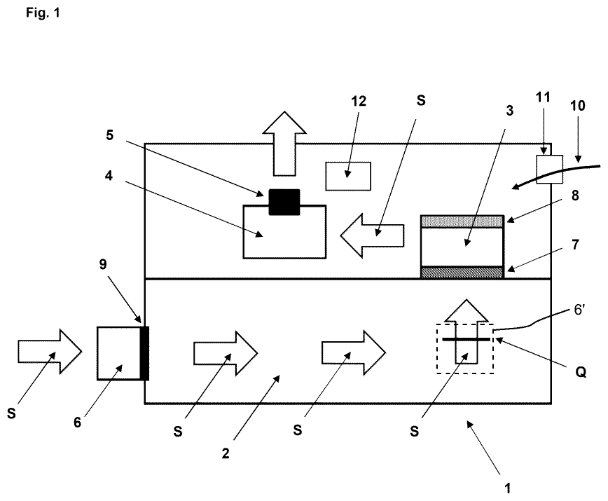

FIG. 1 shows a preferred embodiment of a suction device 1 in the suction mode. The suction device 1 comprises a dirt collection container 2, a filter 3 and a suction motor 4. The suction motor 4 can comprise a turbine 5, the turbine 5 being driven by the suction motor 4 such that a suction flow S is generated. From a technical point of view, the turbine 5 works as a compressor, with air being able to be sucked in with the compressor in order to generate the suction flow S. The suction flow S is used to suck in dust, dirt or a liquid mixture of water and dirt. The suction flow S flows within the suction device 1 in a flow channel or flow path, which is likewise denoted by the reference symbol S. The suction device 1 has an inlet opening 9, with the suction flow S or the flow path S preferably being formed between the inlet opening 9 and the suction motor 4 or the turbine 5. The inlet opening 9 is preferably arranged in the dirt collection container 2 of the suction device 1. A filter 3 is arranged between the inlet opening 9 and the suction motor 4 and is designed to filter out dirt and dust from the suction flow S in order to prevent the suction motor 4 from being contaminated. The filter 3 has a dirty side 7, which preferably faces the dirt collection container 2, and a clean side 8, which faces the suction motor 4 and the suction device head. Within the meaning of the invention, the term “dirty side 7” not only refers to the corresponding side of the filter 3, but preferably also the region of the flow path S between the filter 3 and the inlet opening 9. The wording “on the dirty side” and “between the filter 3 and the inlet opening 9” are preferably to be understood as being synonymous within the meaning of the invention. During the suction mode of the suction device 1, the suction flow S flows from the dirty side 7 in the direction of the clean side 8 through the filter 3, with dust and dirt being filtered out of the suction flow S as it passes through the filter 3. This direction of the suction flow S from the dirty side 7 in the direction of the clean side 8 is shown in FIG. 1 by the arrows which are marked by the reference sign S.

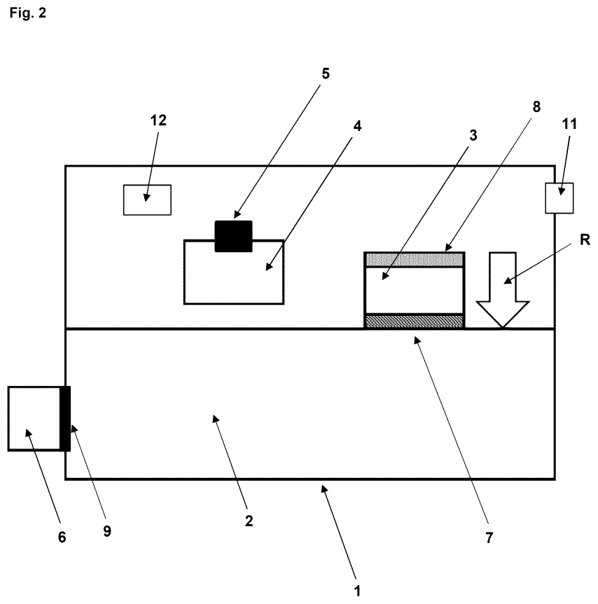

The filter 3 can clog during operation of the suction device 1 or become clogged with a filter cake, as a result of which the suction power of the suction device 1 can be reduced. In this case, what is referred to as filter dedusting, i.e. cleaning of the filter 3 of the suction device 1, has to be carried out. In the context of the present invention, this filter dedusting is carried out by backflushing, i.e. a brief reversal of direction of the suction flow S. During this backflushing, a backflushing flow R (see FIG. 2) flows through or is flushed through the filter 3, with the backflushing flow R flowing from the clean side 8 of the filter 3 in the direction of its dirty side 7. The backflushing flow R is illustrated in FIG. 2. The backflushing flow R can be generated by opening a further inlet opening 11 of the suction device 1, said further inlet opening 11 preferably being able to be arranged in the upper region of the suction device 1 or in the head of the suction device 1 (“suction device head”). The further inlet opening 11 can be opened or closed by a valve, for example. When the valve is opened, ambient air 10 can flow through the further inlet opening 11 into the suction device 1 and can act directly or indirectly on the filter 3.

The suction device 1 has a throttle valve 6 which is preferably arranged in the region of the inlet opening 9 in the dirt collection container 2 of the suction device 1. The throttle valve 6 is arranged in particular in the suction flow S. With the throttle valve 6, the at least one inlet opening 9 of the suction device 1 can be fully or partially opened or closed. In particular, the inlet opening 9 of the suction device 1 can be opened or closed continuously such that the suction flow S can be adjusted, in particular throttled, preferably continuously by the throttle valve 6.

During the suction mode of the suction device 1, a negative pressure forms inside the suction device 1. This negative pressure is responsible for generating the suction flow S, with which dust, dirt and drilling sludge can be sucked in by the suction device 1. For this purpose, the suction device 1 can be connected to a suction hose, the suction hose preferably opening into the suction device 1 in the region of the inlet opening 9. In order to carry out a dedusting of the filter 3, a pressure difference has to be produced between the dirty side 7 and the clean side 8 of the filter 3 in order to generate a backflushing flow R. For this purpose, in particular, the pressure on the clean side 8 of the filter 3 is increased and reduced on the dirty side 7 of the filter 3 such that the backflushing flow R can flow from the clean side 8 in the direction of the dirty side 7 of the filter 3. According to the invention, the pressure reduction on the dirty side 7 of the filter 3 is achieved in particular in that the cross section of the suction flow S through the at least one inlet opening 9 in the dirt collection container 2 of the suction device 1 is reduced such that the suction flow S itself is throttled. In particular, the throttle valve 6 is used to throttle the suction flow S, the throttle valve 6 preferably being able to be actuated manually or activated electrically. In the context of the present invention, an electrically activatable throttle, which is adjustable or controllable in the sense that a flow rate of suction flow S through the inlet opening 9 can be regulated by the throttle valve 6, is very particularly preferred. This allows the pressure drop on the dirty side 7 of the filter 3 of the suction device 1 to be adjusted, as well as the pressure difference between the dirty side 7 and the clean side 8 of the filter 3, and the resulting quality of the filter dedusting. The throttle valve 6 is designed in particular to adjust a cross section Q (see FIG. 1) of the suction channel S. The throttle valve also can be arranged between the inlet opening 9 of the suction device 1 and the filter 3 as shown by alternative throttle valve 6′ in FIG. 1.

The suction device 1 can have a central control unit 12 with which the process of dedusting the at least one filter 3 of the suction device 1 can be controlled. In addition, the suction device 1 can have a further inlet opening 11 through which ambient air 10 can flow into the suction device 1. As a result, a backflushing flow R for dedusting the at least one filter 3 of the suction device 1 can be generated.

### LIST OF REFERENCE SIGNS

1 Suction device
2 Dirt collection container
3 Filter
4 Suction motor
5 Turbine
6 Throttle valve
7 Dirty side
8 Clean side
9 Inlet opening
10 Ambient air
11 Inlet opening in the suction device head
12 Central control unit
S Suction flow/flow channel
Q Cross section

1-13. (canceled)

14. A suction device comprising:
a dirt collection container;
a filter;
a suction motor, wherein a suction flow is generated by the suction motor in a suction mode of the suction device, the suction flow flowing from the dirt collection container through the filter in a direction of the suction motor, the suction device being designed to carry out dedusting of the filter while the suction mode of the suction device is in progress, by a backflushing flow being generated from a clean side of the filter in a direction of a dirty side of the filter; and
a throttle valve on the dirty side of the filter designed to throttle the suction flow such that the backflushing flow is intensified by throttling of the suction flow.

15. The suction device as recited in claim 14 wherein the throttle valve is actuable manually or activatable electrically.

16. The suction device as recited in claim 14 wherein the throttle valve is arranged between an inlet opening of the suction device and the filter.

17. The suction device as recited in claim 14 wherein the throttle valve is arranged at the inlet opening of the suction device.

18. The suction device as recited in claim 14 wherein the throttle valve is arranged in the suction flow.

19. The suction device as recited in claim 14 wherein the throttle valve is designed to adjust a cross section of the suction flow in the suction device.

20. The suction device as recited in claim 19 wherein the throttle valve is designed to adjust the cross section of the suction flow in a range between 0 and 100%.

21. The suction device as recited in claim 14 wherein the throttle valve is designed to adjust a pressure on a dirty side of the filter of the suction device.

22. The suction device as recited in claim 14 further comprising a central control unit for controlling dedusting of the filter.

23. A method for dedusting a filter in the suction device as recited in claim 14, the method comprising the following steps:
a) operating the suction device in the suction mode;
b) carrying out dedusting of the filter while the suction mode is in progress, by the backflushing flow being generated from the clean side of the filter in the direction of the dirty side of the filter; and
c) throttling the suction flow by the throttle valve to intensify the backflushing flow R.

24. The method as recited in claim 23 wherein the throttle valve is actuated manually.

25. The method as recited in claim 23 wherein the throttle valve is actuated electrically.

26. The method as recited in claim 23 wherein a cross section of the suction flow in the suction device is adjusted by the throttle valve in a range between 0 and 100%.

27. The method as recited in claim 23 wherein a pressure on the dirty side of the filter is adjusted by the throttle valve.
